(19) United States
(12) Patent Application Publication
(10) Pub. No.: US 2021/0090077 A1
(43) Pub. Date: Mar. 25, 2021

(54) SYSTEM ARCHITECTURES FOR POINT-OF-SALE DATA OBFUSCATION, DATA REMOVAL AND DATA ENCRYPTION

(71) Applicant: Bank of America Corporation, Charlotte, NC (US)

(72) Inventors: Maria Carolina Barraza Enciso, New York, NY (US); Elena Kvochko, New York, NY (US)

(21) Appl. No.: 16/575,591

(22) Filed: Sep. 19, 2019

(51) Int. Cl. G06Q 20/38; G06Q 20/20; H04L 9/00

(52) U.S. Cl. CPC G06Q 20/38215; H04L 9/008; G06Q 20/209; G06Q 20/204

(57) ABSTRACT

A system for securing payments is provided. The system may include a payment-receiving entity. The payment-receiving entity may include a point-of-sale device, a point-of-sale encryption selection display and a storage medium. The point-of-sale device may include homomorphic encryption capabilities. The system may include a payment processing entity. The payment processing entity may include a payment receiver and a payment processor. Upon receipt of a payment from the user at the payment-receiving entity, the payment-receiving entity may be configured to present to the user the point-of-sale encryption selection display; receive one or more user selections; transmit payment details, associated with the payment, to the payment processing entity; receive payment confirmation; and encrypt and store point-of-sale details based on the user selections. The point-of-sale encryption selection display may be operable to present, to a user, one or more transaction encryption selectable choices.

### FIELD OF TECHNOLOGY

Aspects of the disclosure relate to data obfuscation, data removal and data encryption. Specifically, this disclosure relates to using data obfuscation, data removal and data encryption for securing personal data that is generated at point-of-sale transactions.

### BACKGROUND

During a typical business day, frequent communications may occur between entities. The communications may be conducted electronically. People may conduct the communications. Any suitable entity may conduct any suitable communications. The communications may be initiated by people. The communications may be initiated by devices. The communications may include communications between digital devices and other systems. The communications may include transactions, phone communications or any other suitable communications.

During those communications, the entities may exchange personally-identifiable information. The need exists to protect personally-identifiable information that is exchanged during a transaction. It should be appreciated that, once data is transmitted from a first entity to a second entity, the first entity may lose control over both the data, and how the data is processed. However, a large percentage of the exchanging entities may not have sufficient resources to execute significant personally-identifiable information security programs. Such programs secure the personally-identifiable information.

Additionally, many entities rely on out-of-date infrastructure to execute their transactions. Older infrastructures may collect personally-identifiable information (“PII”) without the data-collecting-entity's knowledge or understanding as to what data is being gathered. Therefore, at times, entities fail to appreciate the type of information that they are collecting and storing. As such, the collected data is stored in a manner that is not compliant with security regulations.

Therefore, it would be desirable to establish a system for prevention of automatic storage of personally-identifiable information. Furthermore, it would be further desirable for personally-identifiable information, which is manually stored at the entity, to be automatically encrypted.

### SUMMARY OF THE DISCLOSURE

Apparatus and methods for protecting transaction metadata privacy are provided. Methods may include receiving a transaction at a first entity. The transaction may include a first tier of transaction details. The first tier of transaction details may include one or more items associated with the transaction. The first tier of transaction details may also include a total amount of the transaction.

The first entity may be a point-of-sale device. The first entity may be a website. The first entity may be any suitable entity.

The first entity may receive the transaction at a cache memory. The cache memory may be a rewriteable cache memory. Upon receipt of a new transaction, the new transaction may write over the previous transaction in cache memory. In the event that a new transaction is not received within a predetermined time period, a reset module may automatically reset the cache memory to erase any remaining data. At the end of a business day, the reset module may also automatically reset the cache memory to erase any remaining data.

Methods may also include forwarding the total amount of the transaction from the first entity to a proxy device. The forwarding may occur prior to the storing. Forwarding the total amount of the transaction prior to storing the transaction details at the first entity may ensure that personally-identifiable information is not stored at the first entity.

The proxy device may be an online payment system. The proxy device may be a mobile payment system. The proxy device may be physical proxy device.

Methods may include requesting, at the proxy device, from the transaction entity, a second tier of transaction details. The second tier of transaction details may be a portion of transaction details that are necessary for the proxy device to process or execute the transaction. The second tier of transaction details may include a transaction entity. The second tier of transaction details may include payment instrument information. Payment instrument information may include banking card details, such as credit card details or debit card details. Payment instrument information may also include mobile wallet details, digital wallet details, mobile payment details, bank account details or any other suitable payment instrument details.

In these embodiments, the second tier of transaction details may be collected by the proxy device and bypass the first entity. Eliminating the second tier of transaction detail retrieval at the first entity may protect personally-identifiable information included in the second tier of transaction details. The protection may be because eliminating the first entity from the transaction detail loop limits the locations where the information is available.

Furthermore, eliminating the second tier of information retrieval from the first entity, may remove the onus from the first entity to properly delete and/or secure the second tier of information.

Methods may include executing the transaction at the proxy device. Executing the transaction may include transferring the funds, preparing a transfer of funds instruction or any other suitable transaction execution.

Methods may also include receiving a transaction confirmation at the first entity. The transaction confirmation may include a transaction confirmation number or alphanumeric code. The transaction confirmation may include a quick response (“QR”) code. The transaction confirmation may also include a transaction confirmation token. In some embodiments, the transaction confirmation may include a binary response, such as yes or no.

The transaction confirmation may be received at the first entity. Upon receipt of a positive confirmation, the first entity may assign a transaction identification number to the transaction. The transaction identification number may be first entity specific. The transaction identification number may include a first entity code. The transaction identification number may also include a transaction confirmation number received from the proxy device.

Methods may include encrypting the transaction confirmation number at the first entity. The transaction confirmation number may be encrypted at the first entity together with the first tier of transaction details. The first tier of transaction details may include the one or more items associated with the transaction and the total amount of the transaction.

The encryption may be homomorphic-type encryption. The encryption may be fully-homomorphic encryption. The encryption may be partially-homomorphic encryption. Homomorphic encryption may be a one-way function to encrypt. Data encrypted by a homomorphic encryption module may be encrypted and may not be able to be decrypted. It should be appreciated that any suitable technology or methods for encryption may be used.

Data encrypted by homomorphic encryption methods may be queried by an authorized user. Such an authorized user may have partial knowledge—i.e., the authorized user may query the system when the authorized user knows a portion of the knowledge, such as transaction number and date, or any other partial knowledge. The queries may provide answers to binary questions, or more sophisticated or configurable queries. As such, an authorized user may be able to obtain constructive analysis from the homomorphically-encrypted data. It should be appreciated that, in a fully-encrypted systems, it may be possible to perform some analytics or machine-learning on the encrypted data using data analytics methods. However, these analytics or machine-learning may be resource-intensive or highly resource consumptive.

Methods may include storing the encrypted transaction identification number together with the one or more items associated with the transaction and the total amount of the transaction. The transaction identification number, one or more items associated with the transaction and the total amount of the transaction may be stored in a storage location. The storage location may be associated with the first entity. The storage location may be a secure storage location. The data stored in the secure storage location may be encrypted data.

In some embodiments, the transaction identification number, one or more items associated with the transaction and the total amount of the transaction may be stored in different storage locations. For example, the transaction identification number may be stored in a first storage location, the one or more items associated with the transaction may be stored in a second storage location and the total amount of the transaction may be stored in a third storage location. Storing the different data elements—i.e., the transaction identification number, the one or more items associated with the transaction and the total amount of the transaction—in separate storage locations may improve the security of the data elements. As such, if a person of malicious intent accesses a storage location, and successfully decrypts the data located in the storage location, the decrypted data may be useless because only a portion of the data elements were made available.

Methods may include printing a receipt. The receipt may include the transaction identification number. The receipt may include the total amount of the transaction. The receipt may be printed electronically. The receipt may be automatically emailed to one or more recipients.

Methods may include receiving one or more binary queries relating to the transaction. The binary query may access the stored encrypted transaction data when the binary query is received from an authorized user. An authorized user may present a limited amount of data to initiate a binary query. The accessed data may provide the basis for a response to the binary query. The authorized user may receive the response. Additionally, it should be appreciated that other queries, not binary queries, may be executed on the homomorphically-encrypted data.

At times, an authorized user without possession of partial data may be unable to retrieve any response or any data from the system.

The binary query may not access the stored encrypted transaction data when the binary query is received from an unauthorized user. In some embodiments, no response may be provided to the unauthorized user. In other embodiments, a response is provided to the unauthorized user. However, the response may only include gibberish.

At times, an unauthorized user without possession of partial data may be unable to retrieve any response or any data, even an unintelligible response, from the system.

It should be appreciated that, because the transaction data is encrypted, a first entity may maintain a separate inventory system. The separate inventory system may determine inventory quantities. The inventory system may not have any information regarding transactions or customer data.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram in accordance with principles of the disclosure;

FIG. 2 shows another illustrative diagram in accordance with principles of the disclosure; and

FIG. 3 shows yet another illustrative diagram in accordance with principles of the disclosure.

### DETAILED DESCRIPTION

Apparatus and methods for point-of-sale data obfuscation, data removal and data encryption are provided. The apparatus and methods may secure payments and transactions that pass through conventional point-of-sale (“POS”) systems.

In some embodiments, a first entity may collect transaction data. The transaction data may include personal customer data, such as a customer name, customer telephone number or other suitable customer data. The transaction data may also include payment instrument information and/or any other suitable data that is required to execute a transaction.

Examples of a first entity may include a merchant, a non-profit organization and/or any other entity that functions as part of a transaction. The first entity may comprise a plurality of entities.

In these embodiments, the first entity may transmit the transaction data to a proxy server for processing. The proxy server may be associated with a financial institution. The proxy server may process or execute the transaction. Upon transaction execution, the proxy server may transmit a result to the first entity.

The first entity may store the result of the transaction—i.e., approval or denial. The first entity may also store the transaction details. The result of the transaction and/or the transaction details may be stored in local storage, such as onsite at a merchant, or offsite storage, such as in the cloud. In some embodiments, the result of the transaction and/or the transaction details may be stored in an encrypted manner.

The encryption manner may be homomorphic encryption. Homomorphic encryption, as described above, may be an irrevocable encryption method. The encrypted data may be accessed by an authorized user by transmitting binary queries to the encrypted data, and receiving responses from the encrypted data. An example of a query may be Did person X conduct a transaction in your store on Sep. 7, 2008? The response provided to the query may be yes or no.

Homomorphic encryption may allow data analytics, artificial intelligence, and machine learning on the encrypted data. The system may be configured to allow some sophisticated queries to gather intelligence such as purchasing-category retrieval. Such purchasing-category retrieval may serve many purposes such as, for example, forecasting or prediction purposes. For example, homomorphic encryption may enable determining the typical purchase categories of a customer, or group of customers, while maintaining the anonymity of the customer, or group of customers. This information may be provided to the merchant.

Predictions may also be executed at the time of purchase or transaction. Predictions may also be executed on a predetermined schedule, such as nightly, or weekly. The predetermined schedule may perform the predictions when the system has greater bandwidth, such as in the evening. Predictions may be applied to the customer at the purchase time or transaction time. Such an encryption system may protect the privacy of the consumers or customers. Although homomorphic encryption protects consumer's privacy, homomorphic encryption does enable a user to execute specific queries on the encrypted data and provides technical, specific information retrieval.

In the event that the homomorphically-encrypted data is compromised, or leaked to external parties, the external party may only be able to view gibberish code or no code at all.

Homomorphic encryption may be computationally intensive. Managing homomorphically-encrypted data may require large amounts of computational power. Therefore, a personal computer (“PC”), which has more computational power than a point-of-sale device, may be linked to the point-of-sale device. The PC may execute the homomorphic encryption and manage the homomorphically-encrypted data. In some circumstances, the point-of-sale device may be equipped with large amounts of computational power and may have the capability to execute the homomorphic encryption and manage the homomorphically-encrypted data.

Additionally, because of the large amounts of computational power that is required to execute the homomorphic encryption, there may be a time lag involved in completing a homomorphically-encrypted transaction.

However, at times, the transaction processing may occur simultaneous to, or in tandem with the transaction encryption. Therefore, the transaction processing time may be similar to, or even greater than, the transaction encryption time. Therefore, in such an embodiment, the time lag may not be significant.

Also, a point-of-sale device may be connected to a 5G network. 5G networks reduce the latency of connection speeds on the network. Specifically, 5G networks double the bandwidth of typical bandwidths. 5G networks may have a bandwidth of 5 GHz, while typical networks may have a bandwidth of 2.5 GHz. Therefore, co-opting the bandwidth of a 5G network in a homomorphically-encrypted transaction may reduce time lags associated with homomorphic encryption.

In some embodiments, a first entity may present an encryption option to the customer. The encryption option may include two choices: whether the customer would like to encrypt the transaction data and wait the extra two seconds, or whether the customer would prefer to leave the transaction data unencrypted and not to wait the extra two seconds.

In some embodiments, the point-of-sale device may present an encryption incentive to the customer. For example, if the customer chooses to wait and encrypt the transaction data, the customer may be presented with a coupon or a price reduction.

In other embodiments, the point-of-sale device may cost share the encryption cost with the customer. The encryption cost may compensate the first entity for additional time and/or additional storage resources required to encrypt the transaction data. In these embodiments, the customer may be charged a small fee to encrypt the data.

In other embodiments, a second entity may provide a data protection storage and encryption service. The second entity may be a payment instrument entity, such as a credit card company or financial institution. The data protection storage and encryption service may merge with the transaction processing service. The data protection storage and encryption service may remain a separate service from the transaction processing service.

The data protection storage and encryption service may communicate with a point-of-sale device. In an example, a customer may swipe or tap a payment instrument at the point-of-sale device. The customer data is encrypted either at the point-of-sale device, in the cloud that communicates with the point-of-sale device or at a platform that communicates with the point-of-sale device. The second entity, associated with the point-of-sale device, may have access to the encrypted customer data. The second entity may perform analysis, queries and/or reporting based on the encrypted data. The data protection storage and encryption service may conceal plain viewing of the customer data from the second entity.

The data protection storage and encryption service may provide a level of security confidence at the second entity level.

In some embodiments, the data encryption is configurable. The data encryption and/or the level of data encryption may depend on a variety of factors. These factors may include the type of transaction, the person associated with the transaction, the point-of-sale location, the second entity and any other suitable factor. In one example, purchasing of a firearm may never be encrypted. In another example, purchases of a known person of malicious intent may never be encrypted. In another example, purchases in a high crime neighborhood may never be encrypted. In another example, food purchases of which the total amount is less than five dollars may always be encrypted. In another example, payments at a doctor's office may always be encrypted. In another example, purchases above a predetermined dollar amount may never be encrypted.

A hierarchical priority index may organize the priority of the configuration factors. Factors that are higher on the index may be considered prior to factors that are lower on the index. In an example, non-encryption of purchases of a known person of malicious intent may precede encryption of food purchases under five dollars. In this example, in the event that a known person of malicious intent executes a food purchase of which the total purchase amount is less than five dollars, the transaction may remain unencrypted.

In some embodiments, the hierarchical priority index may include multiple tiers. A first tier may include data to be stored in an encrypted manner, a second tier may include data to be stored in an unencrypted manner and a third tier may include data to be deleted. Data to be deleted may include low risk data. Low risk data may be defined in certain circumstances. These circumstances may include purchases that total less than a threshold dollar amount, low-risk goods or other suitable circumstances.

Upon execution of the transaction, the customer may be presented a receipt. In some embodiments, the receipt may not include detailed transaction data. The receipt may include a transaction number and a total amount of the transaction. The transaction number may be assigned by the first entity. The receipt may not include specific items purchased or a payment instrument used. The receipt may be presented to the customer.

It should be appreciated that the receipt may be used to return items to the first entity. The customer may present the item with the receipt to the first entity. The first entity may enter the transaction number and the item into the system. The system may execute a query on the homomorphically-encrypted data to determine whether the customer actually made the purchase. The query may include the following binary question: Did transaction number X occur with item X? Upon system confirmation, the first entity may complete the return. At times, the payment instrument that was used may also be required to complete the return.

Upon completion of the return, the system may update the encrypted transaction to indicate that one or more items have been returned. In some embodiments, the return transaction may be a considered a new transaction. In these embodiments, a flag may be appended to the original transaction. The flag may be included in each original transaction. However, the flag may be set to a default value unless specified otherwise. The flag may indicate that a new return transaction, associated with the original transaction, has been processed.

It should be appreciated that the system may optimize the records. Specifically with encrypted data, optimization of records may enable substantially faster record retrieval.

In some embodiments, the system may be customer configurable. For example, the customer may determine if and what elements of the transaction may be encrypted. The customer configurable system may empower customers. For example, some customer may prefer to have complete encryption of their transactions, receive minimal receipts and not receive incentives based on transaction history. Other customers may prefer non-encryption of their transactions, receive more detailed receipts and receive incentives based on transaction history.

This system may be used to enhance the security of non-profit organizations. Many times, donors may want to hide their identity when donating to a specific non-profit organization. Therefore, this system may encrypt the donor data at the point-of-sale device. The encrypted data may be passed to a financial institution to perform the funds transfer. However, the donor data may never be made available to the non-profit organization. The only data that may be made available to the non-profit organization is that a specific dollar amount was transferred into the account of the non-profit organization. This system privatizes the donation and the donor data. This system also shields the non-profit organization from properly securing and being responsible for the donor data.

It should be appreciated that this system improves previous security standards, such as PCI-DSS (“payment card industry data security standard”). PCI-DSS recommends twelve requirements for building a secure payment network, maintaining the secure payment network and security payment data. However, there are many flaws and faults associated with PCI-DSS. These include: unclear specifications, minimum requirements, subjective to interpretation, not required by law, retain the names of the transaction participants, retain a portion of the payment instrument number and only required for a portion of payment instrument holders.

Additionally, PCI-DSS does not provide a framework to which merchants can subscribe. Many merchants do not have the resources to properly implement the PCI-DSS security standards. Therefore, the implementation of a data obfuscation system may provide merchants the ability to comply with security regulations and security standards.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

Apparatus and methods described herein are illustrative. Apparatus and methods of the invention may involve some or all of the features of the illustrative apparatus and/or some or all of the steps of the illustrative methods. The steps of the methods may be performed in an order other than the order shown or described herein. Some embodiments may omit steps shown or described in connection with the illustrative methods. Some embodiments may include steps that are not shown or described in connection with the illustrative methods, but rather shown or described in a different portion of the specification.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

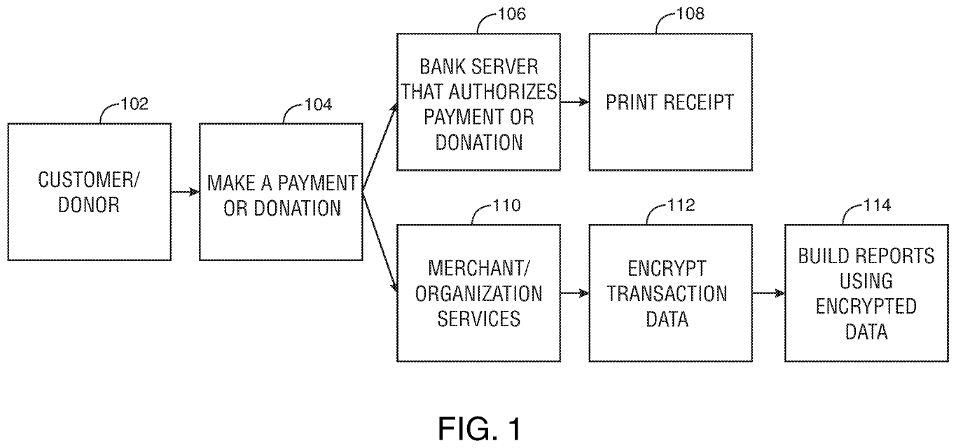

FIG. 1 shows an illustrative flow chart. A customer/donor, shown at 102 may initiate a transaction. The transaction may be a payment or donation, as shown at 104.

Upon receipt of initiation of a payment or donation, the payment or donation data may be duplicated. One set of the duplicate data may be transmitted to a bank server, as shown at 106. The bank server may authorize the payment or donation.

The bank server may print a receipt, as shown at 108. In some embodiments, the bank server may transmit receipt information to the merchant or organization services. The merchant or organization services may print the receipt and transmit to the customer/donor. The receipt may include minimal data, such as a transaction number and total transaction amount.

Another set of the duplicate data may be transmitted to a merchant or organization services, as shown at 110. It should be appreciated that a complete version of the data need not, in some embodiments, be transmitted to the merchant or organization services. The merchant or organization services may encrypt the transaction data, as shown at 112. The merchant or organization services may build reports using encrypted data, as shown at 114. It should be appreciated that data analysis and report generation may be executed on a limited version of the transaction data. The limited version of the transaction data may not include personal data.

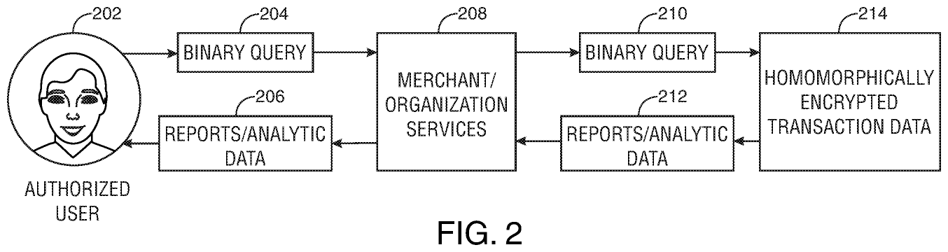

FIG. 2 shows an illustrative flow chart. Authorized user 202 may present binary query, shown at 208, to merchant or organization services 208. Merchant or organization services 208 may present binary query, shown at 210, to homomorphically-encrypted transaction data, shown at 214.

An answer to the binary query may be determined. The answer may be presented as a report or analytic data. The reports and/or analytic data, shown at 212, may be transmitted to the merchant or organization services. The reports and/or analytic data may be transmitted from the merchant or organization services to the authorized user, as shown at 206.

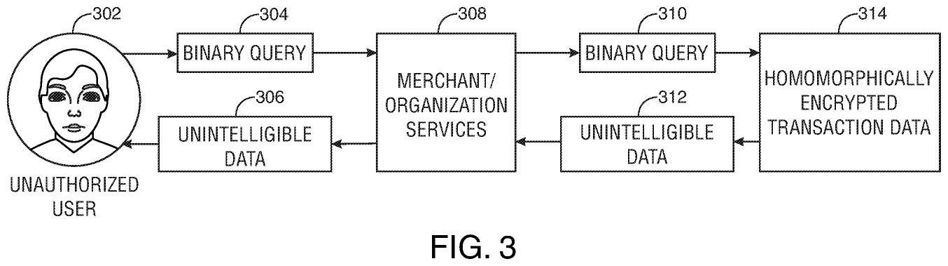

It should be appreciated that data may only be made available to an authorized user. The system may present gibberish, unintelligible data or no data at all to an unauthorized user, as shown in FIG. 3.

FIG. 3 shows an illustrative flow chart. An unauthorized user, shown at 302, may present a binary query, shown at 304, to a merchant or organization services 308. Merchant or organization services 308 may transmit the binary query, shown at 310, to homomorphically-encrypted transaction data, shown at 314. The homomorphically-encrypted transaction data may determine that the binary query was transmitted from an unauthorized user. Therefore, homomorphically-encrypted transaction data may transmit unintelligible data, shown at 312, to merchant or organization services 308. Merchant or organization services 308 may present the unintelligible data, shown at 306, to the unauthorized user, shown at 302.

Thus, systems and methods for system architectures for point-of-sale data obfuscation, data removal and data encryption have been provided. Persons skilled in the art will appreciate that the present invention can be practiced by other than the described embodiments, which are presented for purposes of illustration rather than of limitation.

What is claimed is:

1. A method for protecting transaction metadata privacy, the method comprising:
receiving a transaction at a first entity, the transaction comprising a plurality of transaction details, the transaction details comprising:
a transaction entity;
a payment instrument identifier;
one or more items associated with the transaction; and
a total amount of the transaction;
forwarding, prior to storing, transaction details from the first entity to a proxy device;
executing the transaction at the proxy device;
receiving a transaction confirmation at the first entity;
assigning a transaction identification number to the transaction;
encrypting the transaction identification number, the one or more items associated with the transaction and a total amount of the transaction;
storing the encrypted transaction identification number, the one or more items associated with the transaction and a total amount of the transaction at a storage location associated with the first entity; and
printing a receipt with the transaction identification number and the total amount of the transaction.

2. The method of claim 1 wherein the first entity is a point-of-sale device.

3. The method of claim 1 wherein the first entity is a website.

4. The method of claim 1 wherein the encrypting is a homomorphic-type encryption.

5. The method of claim 4 further comprising receiving, from an authorized user, one or more binary queries relating to the transaction.

6. The method of claim 5 further comprising accessing, based on the one or more binary queries, the stored encrypted transaction data.

7. The method of claim 6 further comprising responding to the binary queries based on the accessed data.

8. A method for protecting transaction metadata privacy, the method comprising:
receiving a transaction at a first entity, the transaction comprising a first tier of transaction details, the first tier of transaction details comprising:
one or more items associated with the transaction; and
a total amount of the transaction;
forwarding, prior to storing, the total amount of the transaction from the first entity to a proxy device;
requesting, at the proxy device, from the transaction entity, a second tier of transaction details, the second tier of transaction details comprising:
a transaction entity; and
payment instrument information;
executing the transaction at the proxy device;
receiving a transaction confirmation at the first entity;
assigning, at the first entity, a transaction identification number to the transaction;
encrypting, at the first entity, the transaction identification number together with the one or more items associated with the transaction and the total amount of the transaction;
storing the encrypted transaction identification number together with the one or more items associated with the transaction and the total amount of the transaction at a storage location associated with the first entity; and
printing a receipt with the transaction identification number and the total amount of the transaction.

9. The method of claim 8 wherein the first entity is a point-of-sale device.

10. The method of claim 8 wherein the first entity is a website.

11. The method of claim 8 wherein the proxy device is an online payment system.

12. The method of claim 8 wherein the encrypting is a homomorphic-type encryption.

13. The method of claim 12 further comprising receiving, from an authorized user, one or more binary queries relating to the transaction.

14. The method of claim 13 further comprising accessing, based on the one or more binary queries, the stored encrypted transaction data.

15. The method of claim 14 further comprising responding to the binary queries based on the accessed data.

16. A system for securing payments, the system comprising:
a payment-receiving entity, said payment-receiving entity comprising:
a point-of-sale device, said point-of-sale device comprising homomorphic encryption capabilities;
a point-of-sale encryption selection display operable to present, to a user, a plurality of transaction encryption selectable choices, said plurality of transaction encryption selectable choices comprising:
complete encryption;
payment instrument data encryption; and
no encryption; and
a storage medium;
a payment processing entity, said payment-processing entity comprising:
a payment receiver; and
a payment processor;
wherein:
upon receipt of a payment from the user at the payment-receiving entity, the payment-receiving entity is configured to:
present to the user the point-of-sale encryption selection display;
receive one or more user selections;
transmit payment details, associated with the payment, to the payment processing entity;
receive payment confirmation; and
encrypt and store, in the storage medium, point-of-sale details based on the user selection.

17. The system of claim 16 wherein the payment-receiving entity is a separate entity than a merchant entity.

18. The system of claim 16 wherein the encryption is homomorphic encryption.

19. The system of claim 16 wherein, the point-of-sale user selection display comprises a complete encryption option.

20. The system of claim 19 wherein upon user selection of the complete encryption option, the payment details are homomorphically-encrypted prior to storage at the payment-receiving entity, and a receipt associated with the payment details include a transaction number and a total transaction amount.
